(19) United States
(12) Patent Application Publication
(10) Pub. No.: US 2022/0378641 A1
(43) Pub. Date: Dec. 1, 2022

(54) DENTAL CHAIR

(71) Applicant: Tsung-Lung Hsieh, Kaohsiung City (TW)

(72) Inventor: Tsung-Lung Hsieh, Kaohsiung City (TW)

(73) Assignee: Tsung-Lung Hsieh, Kaohsiung City (TW)

(21) Appl. No.: 17/453,535

(22) Filed: Nov. 4, 2021

(30) Foreign Application Priority Data
May 25, 2021 (TW) 110205994

(51) Int. Cl. A61G 15/14; A61G 15/02; A61G 15/12

(52) U.S. Cl. CPC A61G 15/14; A61G 15/02; A61G 15/125; A61G 2203/16; A61G 2203/20

(57) ABSTRACT

A dental chair is adapted to be used in cooperation with a dental scanning instrument. The dental chair includes a chair unit, an adjustable support arm, and a display unit. The adjustable support arm has a first end that is connected to the chair unit, and a second end that is opposite to the first end. The adjustable support arm is adjustable in a segment-by-segment manner to move the second end relative to the first end. The display unit is connected to the second end of the adjustable support arm and is adapted to be in signal communication with the dental scanning instrument for displaying an image generated by the dental scanning instrument.

### CROSS-REFERENCE TO RELATED APPLICATIONS

This application claims priority of Taiwanese Patent Application No. 110205994, filed on May 25, 2021.

### FIELD

The disclosure relates to a dental chair, and more particularly to a dental chair incorporating a display unit.

### BACKGROUND

Referring to FIG. 1, a commonly available intraoral scanner 11 used in cooperation with a display device 12 is illustrated. Such an intraoral scanner 11, when sold to a dental clinic or a dentist, usually comes with an externally connected display device 12 that is in signal communication with the intraoral scanner 11. The externally connected display device 12 sold together with the intraoral scanner 11 includes a screen and a movable stand. The dentist (A1) can move the display device 12 to an appropriate position for use. The dentist (A1) operates the intraoral scanner 11 to scan the oral cavity of a patient (A2) to enable the intraoral scanner 11 to generate a three dimensional (3D) image of the patient's oral cavity. The 3D image is to be synchronously displayed on the display device 12 for viewing by the dentist (A1).

However, the disposition of the display device 12 may not be convenient for the dentist (A1). For example, when the display device 12 is located directly in front of the dentist (A1), the dentist (A1) must look up frequently to watch the display device 12 and view the 3D images generated by the intraoral scanner 11. When the display device 12 is located on one side of the patient (A2), the dentist (A1) must turn his/her head frequently to view the 3D image. Therefore, during diagnosis and treatment, the dentist (A1) must keep switching his/her field of view between the oral cavity of the patient (A2) and the display device 12. This will adversely affect work efficiency. Moreover, over a long session of diagnosis and treatment, the repetitive neck movement would cause head and neck fatigue and soreness, and would adversely affect the dentist's health.

### SUMMARY

Therefore, the object of the disclosure is to provide a dental chair incorporating a display unit that is more convenient for use in diagnosis and treatment and can effectively improve work efficiency.

According to the disclosure, the dental chair is adapted to be used in cooperation with a dental scanning instrument. The dental chair includes a chair unit, an adjustable support arm, and a display unit. The adjustable support arm has a first end that is connected to the chair unit, and a second end that is opposite to the first end. The adjustable support arm is adjustable in a segment-by-segment manner to move the second end relative to the first end. The display unit is connected to the second end of the adjustable support arm and is adapted to be in signal communication with the dental scanning instrument for displaying an image generated by the dental scanning instrument.

### BRIEF DESCRIPTION OF THE DRAWINGS

Other features and advantages of the disclosure will become apparent in the following detailed description of the embodiment with reference to the accompanying drawings, of which:

FIG. 1 is a schematic diagram illustrating a conventional intraoral scanner used with an externally connected display device;

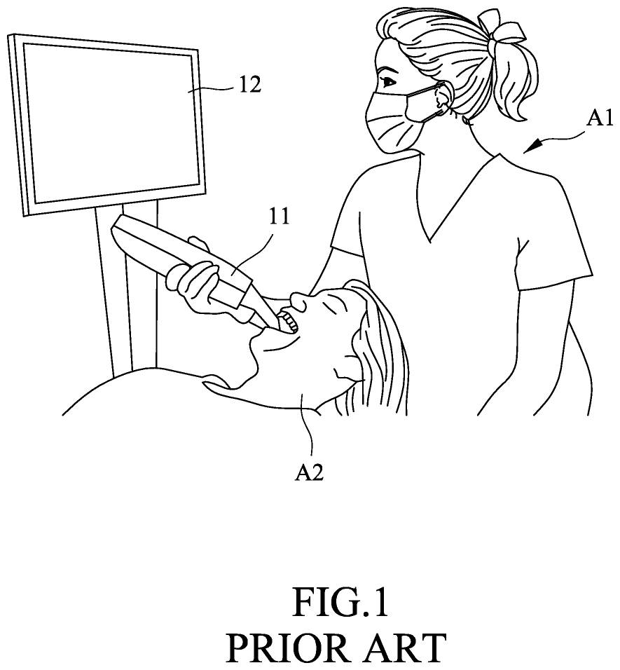

FIG. 2 is a fragmentary perspective view illustrating an embodiment of a dental chair according to the disclosure;

FIG. 3 is a schematic diagram illustrating an example of use of this embodiment;

FIG. 4 is a fragmentary perspective view illustrating a variation of an adjustable support arm of the embodiment;

FIG. 5 is a fragmentary perspective view illustrating a variation of a second connecting member of the embodiment; and

FIG. 6 is a schematic diagram illustrating another example of use of the embodiment.

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

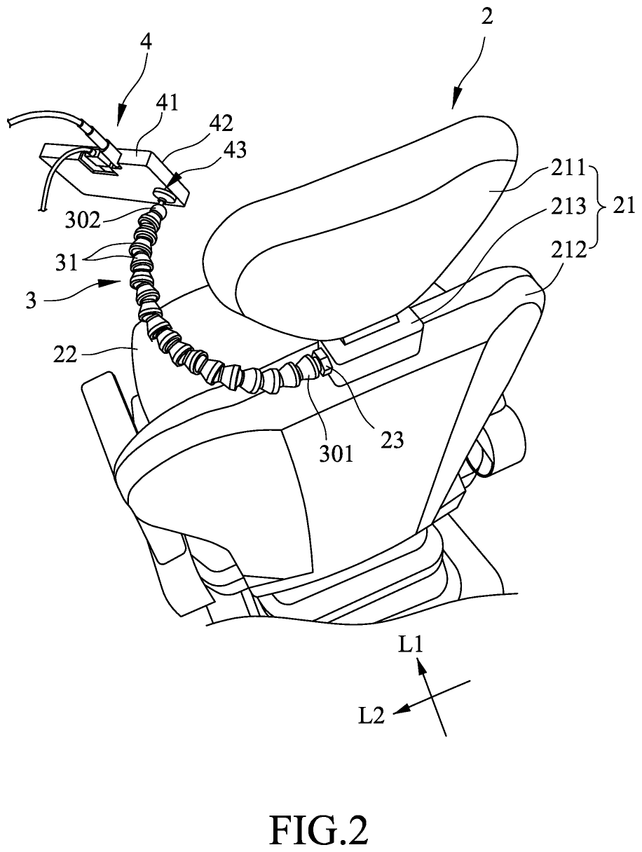

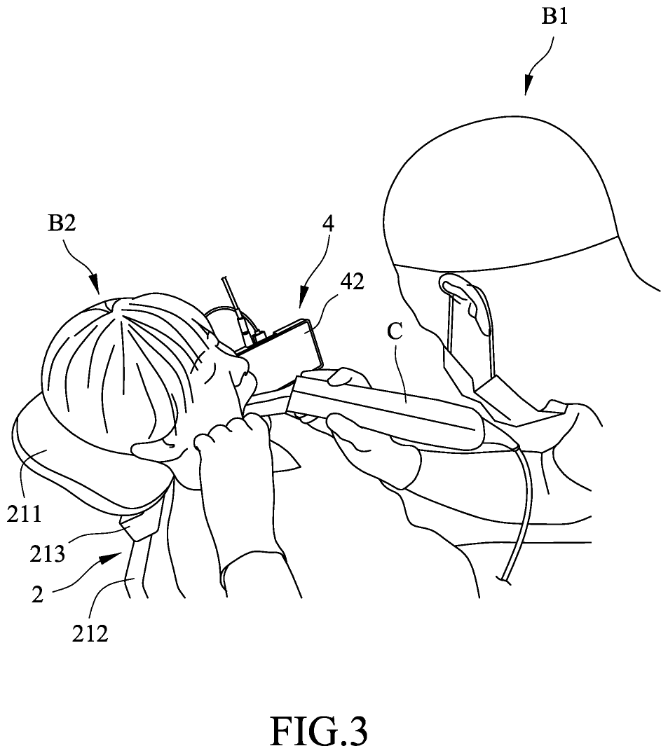

As shown in FIGS. 2 and 3, the embodiment of a dental chair according to the present disclosure is suitable for use with a dental scanning instrument (C). The dental scanning instrument (C) is an intraoral scanner that is controlled and operated by a dentist (B1), but in other embodiments, the dental scanning instrument (C) may be an intraoral camera. The embodiment of the dental chair includes a chair unit 2, an adjustable support arm 3 arranged on the chair unit 2, and a display unit 4 connected to the adjustable support arm 3.

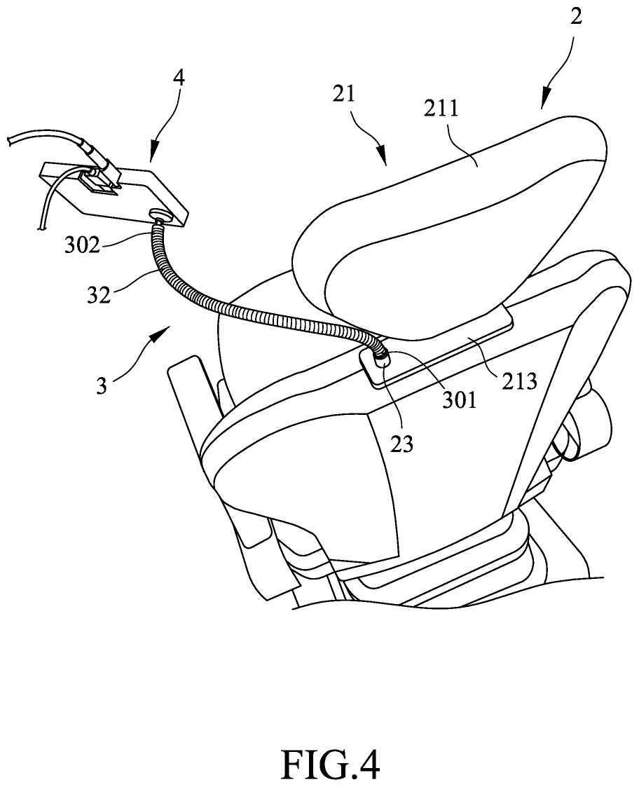

The chair unit 2 is provided for a patient (B2) to lie down in a front-rear direction (L1), and includes an upper chair part 21 for the upper body of the patient (B2) to lean against, a lower chair part 22 connected with the upper chair part 21 for the lower body of the patient (B2) to sit on, and a first connecting member 23 laterally projecting from the upper chair part 21 in a left-right direction (L2). The upper chair part 21 has a headrest portion 211 for the head of the patient (B2) to lean on, a body portion 212 for the torso and arms of the patient (B2) to rest, and a neck portion 213 connecting the headrest portion 211 to the body portion 212. In this embodiment, the first connecting member 23 is in the form of a ball-and-socket connector and is disposed on the neck portion 213, but the form and disposition of the first connecting member 23 are not limited to the disclosure herein, as long as the first connecting member 23 is disposed on the upper chair part 21. In addition, the position where the first connecting member 23 is disposed on the neck portion 213 is not limited to this embodiment. As illustrated in FIG. 2, the first connecting member 23 is arranged on a lateral side of the neck portion 213. However, the first connecting member 23 can also be arranged on a top side of the neck portion 213 according to different requirements, as shown in FIG. 4.

The adjustable support arm 3 is elongated, and includes a plurality of sequentially arranged articulated segments 31 operable to change the shape of the adjustable support arm 3 and to allow the adjustable support arm 3 to keep the shape thus changed. A terminal one of the articulated segments 31 is connected with the first connecting member 23 of the chair unit 2 and referred to as a first end 301 of the adjustable support arm 3. The other terminal one of the articulated segments 31, opposite to the first end 301, is connected to the display unit 4 and referred to as a second end 302 of the adjustable support arm 3. The first end 301 includes one of a ball head and a socket base coupled to each other, while the first connecting member 23 includes the other one of the ball head and the socket base. The first end 301 and the first connecting member 23 cooperate to form a ball-and-socket joint. In this embodiment as shown in FIG. 2, the first end 301 includes a socket base, and the first connecting member 23 includes a ball head. Each articulated segment 31 is rotatable relative to adjacent one(s) of the articulated segments 31 within a limited range in all directions so that the adjustable support arm 3 can be adjusted in a segment-by-segment manner to move the second end 302 relative to the first end 301. In this embodiment, any two adjacent articulated segments among the articulated segments 31 are also connected in a manner of a ball-and-socket joint. In addition, because the first end 301 is rotatable relative to the first connecting member 23, the adjustable support arm 3 can swivel relative to the first connecting member 23, which further improves operational flexibility of the adjustable support arm 3.

Referring to FIG. 4, in a variation of the embodiment, the adjustable support arm 3 can be configured differently compared to that shown in FIG. 2 according to different requirements. In this variation of the embodiment, the adjustable support arm 3 is a flexible gooseneck tube that has a tube body 32. The tube body 32 includes an inner spring, and an outer wire wound around the inner spring and compressed into gaps between coils of the inner spring. The tube body 32 has opposite ends that are connected respectively to the chair unit 2 and the display unit 4, and that respectively serve as the first end 301 and the second end 302 of the adjustable support arm 3. By virtue of the structure of the coils of the inner spring and the outer wire, the tube body 32 can be operated to adjust the relative position of the first end 301 and the second end 302 in a segment-by-segment manner and to allow the second end 302 to stay in position after being moved. In this variation of the embodiment, slightly different from the embodiment shown in FIG. 2, the neck portion 213 of the upper chair part 21 extends longer, and the first connecting member 23 is disposed on the top side of the neck portion 213. In this variation of the embodiment, since the first connecting member 23 does not occupy the space at the lateral side of the neck portion 213, dimensions of the lateral side can be reduced and the neck portion 213 can be made thinner, thus reducing material cost and improving convenience of assembly.

Referring to FIGS. 2 and 3, the display unit 4 is in signal communication with the dental scanning instrument (C) for displaying an image generated by the dental scanning instrument (C). The dental scanning instrument (C) is operated by the dentist (B1) to scan the oral cavity of the patient (B2) to generate the image of the patient's oral cavity. The display 4 includes a housing 41, a screen 42 embedded in the housing 41 for image display, and a second connecting member 43 detachably connected to the housing 41. The screen 42 is, for example, a touch screen so that the dentist (B1) may conveniently adjust the on screen image via touch interface while performing dental operations. The second connecting member 43 is, but not limited to, a ball-and-socket connector projecting outward from the housing 41 and rotatably connected to the second end 302 of the adjustable support arm 3. Similar to the first end 301 and the first connecting member 23, the second end 302 includes one of a ball head and a socket base coupled to each other, while the second connecting member 43 includes the other one of the ball head and the socket base. The second end 302 and the second connecting member 43 cooperate to form a ball-and-socket joint. In this embodiment, the second end 302 includes a socket base, and the second connecting member 43 includes a ball head. In particular, through the configuration of the adjustable support arm 3 allowing segment-by-segment adjustment of the position of the second end 302 relative to the first end 301, the display unit 4 can be moved relative to the chair unit 2, thereby providing higher operational flexibility. Moreover, through the mechanism of ball-and-socket joint formed by the second connecting member 43 and the second end 302, the display unit 4 can be rotated relative to the adjustable support arm 3, which further improves the operational capability.

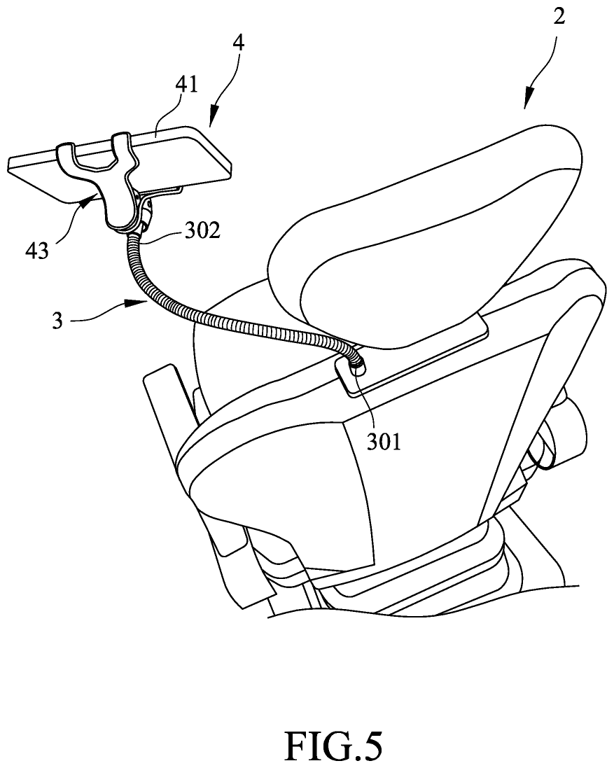

Referring to FIG. 5, in a variation of the embodiment, the second connecting member 43 is a holder connected to the second end 302 and operable to clamp the housing 41. Alternatively, the second connecting member 43 may include another fastening mechanism, such as a magnet, a bayonet mount, a suction cup, and so on, so that the display unit 4 can be connected to the adjustable support arm 3 according to the needs of different users.

Referring to FIGS. 2 and 3, during diagnosis and treatment, the dentist (B1) controls the dental scanning instrument (C) to scan the oral cavity of the patient (B2) to produce an image, such as a digital three-dimensional image, which is transmitted to the display unit 4 for viewing by the dentist Bl, thus facilitating the diagnosis and treatment of the patient (B2). The dentist B1 can adjust the relative position of the display unit 4 and the chair unit 2 to place the display unit 4 near the oral cavity of the patient B2 so that both the patient's oral cavity and the screen 42 of the display unit 4 are in the field of view of the dentist (B1), as depicted in FIG. 3. Therefore, the dentist (B1) does not need to turn his/her head and neck to view the image displayed on the screen 42 when operating the dental scanning instrument (C), thus improving diagnosis and treatment efficiency and reducing accidental injury to the patient (B2). In addition, since the display unit 4 can be adjusted to an appropriate position according to the needs of the dentist (B1), the arrangement is more compliant with ergonomic requirements. Even during extended treatments, the head and neck of the dentist B1 are less prone to fatigue and soreness.

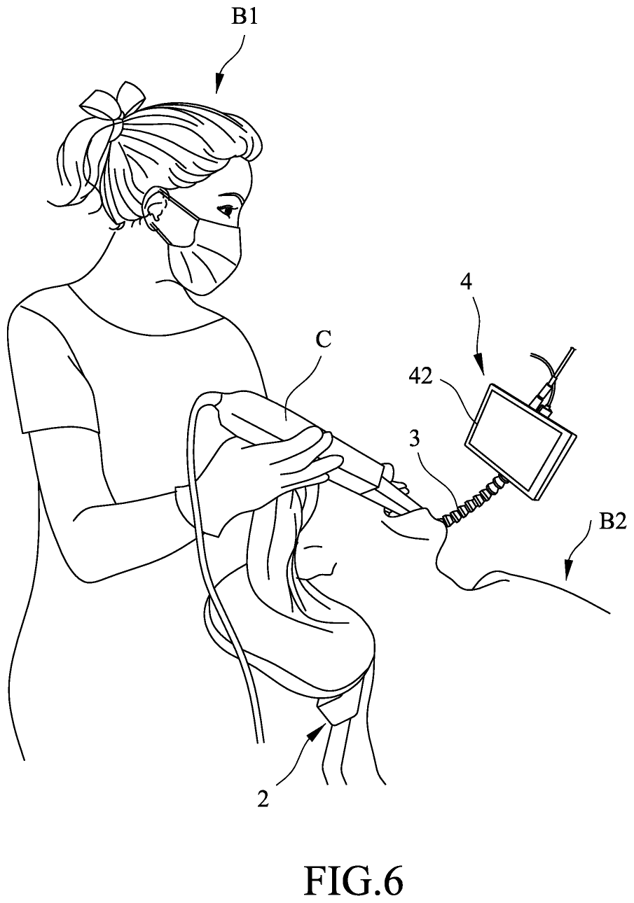

Referring to FIG. 6, it is noted that since the adjustable support arm 3 can be adjusted segment-by-segment, when the dentist (B1) is behind the chair unit 2 and the patient (B2), and manipulates the dental scanning instrument (C) during the diagnosis and treatment, the display unit 4 can be rotated to face the dentist B1 so that the image displayed by the display unit 4 is in the field of view of the dentist B1 and the dentist (B1) can view the image without changing posture. In other words, this embodiment can be adjusted according to the position and habits of the dentist (B1) at any time during the process of diagnosis and treatment, which is more efficient and can improve the convenience for the dentist (B1). Referring to FIG. 2, since the first connecting member 23 is disposed on the neck portion 213 and the adjustable support arm 3 is partly located in the space between the headrest portion 211 and the body portion 212, space utilization is optimized and the dental chair incorporating a display unit thus has a compact design. In addition, in a situation where the adjustable support arm 3 protrudes too far outward and hits other equipment when moving the chair unit 2 may be prevented. In summary, in the dental chair incorporating a display unit according to the disclosure, through adjusting the adjustable support arm 3 segment-by-segment, the relative position of the second end 302 and the first end 301 of the adjustable support arm 3 can be changed so that the display unit 4 connected with the second end 302 can be moved relative to the chair unit 2 and moved directly into the field of view of the dentist Bl, thus facilitating operation efficiency and further improving the workflow efficiency. Moreover, the risk of occupational injuries to the dentist (B1) stemming from neck fatigue and soreness can be reduced, so the object of the disclosure can be achieved.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A dental chair adapted to be used in cooperation with a dental scanning instrument, said dental chair comprising;
a chair unit;
an adjustable support arm having a first end that is connected to said chair unit, and a second end that is opposite to said first end, said adjustable support arm being adjustable in a segment-by-segment manner to move said second end relative to said first end; and
a display unit connected to said second end of said adjustable support arm and adapted to be in signal communication with the dental scanning instrument for displaying an image generated by the dental scanning instrument.

2. The dental chair as claimed in claim 1, wherein said chair unit includes an upper chair part and a lower chair part connected with said upper chair part, said first end of said adjustable support arm being connected to a lateral side of said upper chair part.

3. The dental chair as claimed in claim 2, wherein said upper chair part has a headrest portion, a body portion, and a neck portion connecting said headrest portion to said body portion, said first end of said adjustable support arm being connected to said neck portion.

4. The dental chair as claimed in claim 2, wherein said chair unit further includes a first connecting member laterally projecting from said upper chair part and connected to said first end of said adjustable support arm, said first connecting member being in the form of a ball-and-socket connector.

5. The dental chair as claimed in claim 1, wherein said adjustable support arm includes a plurality of sequentially arranged articulated segments, each of said articulated segments being rotatable relative to an adjacent one of said articulated segments, a terminal one of said articulated segments that is connected to said chair unit serving as said first end of said adjustable support arm, the other terminal one of said articulated segments that is connected to said display unit serving as said second end of said adjustable support arm.

6. The dental chair as claimed in claim 1, wherein said adjustable support arm is a gooseneck tube that has a tube body which has opposite ends serving as said first end and said second end of said adjustable support arm, respectively.

7. The dental chair as claimed in claim 1, wherein said display unit includes a housing, a screen embedded in said housing, and a second connecting member connected to said second end of said adjustable support arm and detachably connected to said housing.

8. The dental chair as claimed in claim 7, wherein said second connecting member is a ball-and-socket connector projecting from said housing and connected to said second end.

9. The dental chair as claimed in claim 7, wherein said screen is a touch screen.

10. The dental chair as claimed in claim 7, wherein said second connecting member is a holder operable to clamp said housing of said display unit.
